(19) United States
(12) Patent Application Publication
(10) Pub. No.: US 2008/0126881 A1
(43) Pub. Date: May 29, 2008

(54) Method and apparatus for using performance parameters to predict a computer system failure

(76) Inventor: Tilmann Bruckhaus, Sunnyvale, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(21) Appl. No.: 11/493,728

(22) Filed: Jul. 26, 2006

(51) Int. Cl. G06F 11/00

(52) U.S. Cl. 714/47; 714/E11.144

(57) ABSTRACT

One embodiment of the present invention provides a system that uses performance parameters to predict a computer system failure. The system operates by evaluating a performance-parameter rule on a target system to determine if a corresponding performance parameter is within a predetermined range. Note that the performance parameter defines a performance metric for software, including an operating system, executing on the computer system. Note that the performance parameter may also define a performance metric for hardware and networks, and can come from other sources such as vendor-internal records. The system also receives an evaluation result of the performance-parameter rule from the target system. Next, the system records the evaluation result in a historic data set. The system then determines if the target system failed within a pre-determined time period subsequent to the evaluation of the performance-parameter rule. If so, the system records the failure of the target system in the historic data set. Finally, the system analyzes the historic data set to determine the accuracy of using the performance-parameter rule to predict a failure of the target system.

### FIELD OF THE INVENTION

The present invention relates to computer systems. More specifically, the present invention relates to a method and an apparatus for using performance parameters to predict a computer system failure.

### RELATED ART

As electronic commerce grows increasingly more prevalent, businesses are increasingly relying on enterprise computing systems to process ever-larger volumes of electronic transactions. A failure in one of these enterprise computing systems can be disastrous, potentially resulting in millions of dollars of lost business. More importantly, a failure can seriously undermine consumer confidence in a business, making customers less likely to purchase goods and services from the business.

Computer system designers have tried to prevent computer system failures by creating systems which can predict when computers have a high risk of failure before a failure occurs. One approach to predicting failures is to use physical sensors in the computer systems to detect abnormal operating conditions. For example, excessive heat or excessive noise may be a sign of impending failure. While these techniques have been effective at predicting some failures, other types of failures can occur, which do not present abnormal conditions to these sensors prior to failure. Furthermore, it can be expensive to deploy physical sensors, and the physical sensors and associated monitoring circuitry can greatly increase the complexity or a computer system.

In high-end computing servers there is an extremely complex interplay of dynamic performance parameters that characterize the state of the system. For example, in high-end servers, these dynamic performance parameters can include system performance parameters, such as parameters having to do with throughput, transaction latencies, queue lengths, load on the CPU and memories, I/O traffic, bus-saturation metrics, and FIFO overflow statistics. They can also include physical parameters, such as distributed internal temperatures, environmental variables, currents, voltages, and time-domain reflectometry readings. Although it is possible to sample all of these performance parameters, it is by no means obvious what pattern or, “signature” among multiple performance parameters may accompany or precede a computer system failure.

Existing systems sometimes place “threshold limits” on specific performance parameters. However, placing a threshold limit on a specific performance parameter does not help in identifying a more complex pattern among multiple performance parameters that may be associated with a computer system failure.

Hence, what is needed is a method and an apparatus for predicting the failures in a computer system without the problems listed above.

### SUMMARY

One embodiment of the present invention provides a system that uses performance parameters to predict a computer system failure. The system operates by evaluating a performance-parameter rule on a target system to determine if a corresponding performance parameter is within a predetermined range. Note that the performance parameter defines a performance metric for software, including an operating system, executing on the computer system. Note that the performance parameter may also define a performance metric for hardware and networks, and can come from other sources such as vendor-internal records. The system also receives an evaluation result of the performance-parameter rule from the target system. Next, the system records the evaluation result in a historic data set. The system then determines if the target system failed within a pre-determined time period subsequent to the evaluation of the performance-parameter rule. If so, the system records the failure of the target system in the historic data set. Finally, the system analyzes the historic data set to determine the accuracy of using the performance-parameter rule to predict a failure of the target system.

In a variation on this embodiment, prior to analyzing the historic data set, the system repeats the process of evaluating the performance-parameter rule, receiving the evaluation result, recording the evaluation result, and identifying and recording failures of the target system for subsequent time periods.

In a further variation, the system evaluates a second performance-parameter rule on the target system to determine if a second performance parameter is within a second predetermined range. The system also receives a second evaluation result of the second performance-parameter rule from the target system. Next, the system records the second evaluation result of the second performance-parameter rule in the historic data set. The system then determines if the target system failed within a pre-determined time period subsequent to the evaluation of the second performance-parameter rule, and if so, records the failure of the target system in the historic data set. The system also repeats the process of evaluating the second performance-parameter rule on the target system, receiving the second evaluation result of the second performance-parameter rule, recording the second evaluation result, and determining and recording failures of the target system for subsequent time periods. Finally, the system analyzes the historic data set to determine the accuracy of using the second performance-parameter rule to predict a failure of the target system.

In a variation on this embodiment, the system analyzes the historic data set to determine the accuracy of using a combination of performance-parameter rules to predict a failure of the target system.

In a further variation, the system periodically analyzes evaluation results of the performance-parameter rules to determine the probability of an impending failure of the target system. If the probability is above a pre-determined threshold, the system alerts an administrator.

In a variation on this embodiment, the system implements an automatic failover of the target system to a backup system if the probability is above a pre-determined threshold.

In a variation on this embodiment, the system receives data from a sensor which is monitoring physical attributes of the target system and records the data from the sensor in the historic data set. The system then determines if the target system failed within a pre-determined time period subsequent to recording the data from the sensor in the historic data set, and if so, records the failure of the target system in the historic data set. Finally, the system analyzes the historic data set to determine the accuracy of using a combination of performance parameters and sensor data to predict a failure of the target system.

### BRIEF DESCRIPTION OF THE FIGURES

FIG. 1 illustrates a monitoring environment in accordance with an embodiment of the present invention.

FIG. 2 presents a flowchart illustrating the process of creating and evaluating performance parameters in accordance with an embodiment of the present invention.

FIG. 3 illustrates performance parameter evaluation data in accordance with an embodiment of the present invention.

FIG. 4 illustrates measured precision of performance parameters in accordance with an embodiment of the present invention.

FIG. 5 illustrates bit strings representing the evaluation of subsets of performance parameters in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### Overview

Computer users and computer manufacturers sometimes seek to prevent computer system failures by creating systems which can predict when computers have a high risk of failure before a failure occurs. One approach to predicting failures is to evaluate a set of performance-parameter rules that specify acceptable ranges of corresponding performance parameters. These performance parameters typically address various aspects of the configuration and usage of the computer. Thus, when some of these performance-parameter rules are triggered, it may indicate that the computer is at risk of incurring a failure. Note that the present invention focuses on the use of performance parameters, as opposed to sensor data, to predict computer system failures. These performance parameters can include any metric obtainable from software running on the target system, including, but not limited to, network throughput, transaction latencies, queue lengths, loads on the CPU and memory, I/O traffic, bus-saturation metrics, available storage space, storage access times, and FIFO overflow statistics. In addition, these performance parameters may also define a performance metric for hardware and networks, and can come from other sources such as vendor-internal records. However, one embodiment of the present invention uses sensor data along with the performance parameters to predict computer system failures.

One difficulty with predicting failures based on evaluating performance-parameter rules is to determine which specific combination of performance-parameter rules can be used to predict failures with high accuracy. For example, a computer user or manufacturer may have thousands of performance-parameter rules defined for periodic evaluation. Many of these performance-parameter rules may not be helpful in predicting failures, so a count, or a weighted count, of the number of performance-parameter rules that fail may not be predictive of a failure. Similarly, individual performance-parameter rules are not typically good predictors of failures. Therefore, an important problem is to identify a subset of a set of performance-parameter rules which can be used to predict a failure.

One embodiment of the present invention provides a system that optimizes the selection of performance-parameter rules used for prediction of failures in the following phases:
performance-parameter rule definition;
performance-parameter rule evaluation;
optimization seeding phase;
genetic optimization phase; and
prediction phase.

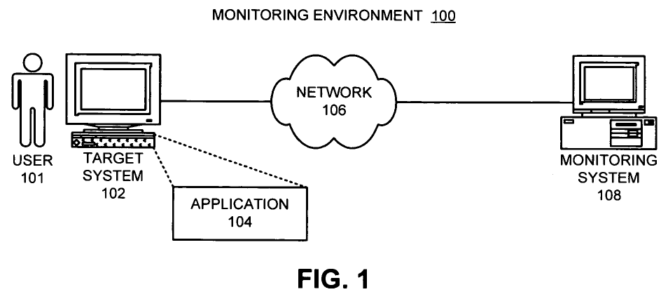

For example, FIG. 1 illustrates a monitoring environment 100 in accordance with an embodiment of the present invention. Monitoring environment 100 includes user 101, target system 102, network 106, and monitoring system 108.

Target system 102 and monitoring system 108 can generally include any node on a network including computational capability and including a mechanism for communicating across the network.

Network 106 can generally include any type of wired or wireless communication channel capable of coupling together computing nodes. This includes, but is not limited to, a local area network, a wide area network, or a combination of networks. In one embodiment of the present invention, network 106 includes the Internet.

In one embodiment of the present invention, monitoring system 108 and target system 102 are the same system. In another embodiment of the present invention, monitoring system 108 is operated by a third-party monitoring service, and is not located in close physical proximity to target system 102.

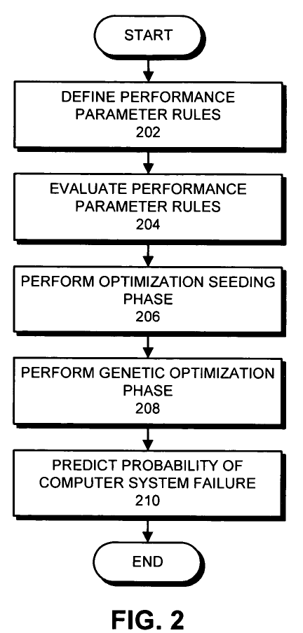

FIG. 2 presents a flowchart illustrating the process of creating and evaluating performance-parameter rules in accordance with an embodiment of the present invention. The system operates by receiving a definition of performance-parameter rules from user 101 (step 202). The performance parameters associated with these performance-parameter rules can include performance data for the operating system running on target system 102, as well as for application 104. For example, these performance-parameter rules can specify an amount of available memory required for application 104, or the minimum amount of available disk space that should be maintained.

Next, the system evaluates the performance-parameter rule and records whether it was followed by a failure of target system 102 (step 204). The system then performs an optimization seeding phase on each performance-parameter rule determining the accuracy of using the performance parameter at predicting a failure of target system 102 (step 206). The system also performs a genetic-seeding phase (step 208) to determine the accuracy of using various subsets of the performance-parameter rules to predict a failure of target system 102. Finally, the system uses the performance-parameter rules to predict a failure of target system 102 (step 210). The steps described in FIG. 2 are described in further detail below.

### Performance Parameter Definition

In one embodiment of the present invention, in the performance-parameter-rule-definition phase, a set of performance-parameter rules are typically defined by human experts. For example, a performance-parameter rule may state that a computer system running application 104 should be equipped with at least one gigabyte of memory, or should have at least one gigabyte of memory available to application 104. These performance-parameter rules are then coded so that they can be evaluated automatically on a computer system for which failure risk is to be predicted. For example, a Java™ program can be written to check whether application 104 is running on the target system 102 and whether the target system 102 has at least one gigabyte of memory. (The terms JAVA, JVM and JAVA VIRTUAL MACHINE are trademarks of SUN Microsystems, Inc. of Santa Clara, Calif.) If application 104 is running on the target system 102 and the target system 102 has less than one gigabyte of memory available, then the performance-parameter rule results in a “fail” condition, otherwise the performance-parameter rule results in a “pass” condition.

### Performance Parameter Evaluation

In one embodiment of the present invention, all performance-parameter rules are applied to all target systems and the results are recorded. Each performance-parameter rule evaluation may lead to a variety of possible alternative results such as “pass”, “fail”, “evaluation error”, and “not applicable”, or a similar set of possible outcomes. Similarly, failures are also recorded so that one can determine which performance-parameter rule evaluation results preceded a failure. Each time a target system fails, the performance-parameter rule evaluation data set that was last collected before the failure is then tagged as an evaluation which preceded a failure. Conversely, performance-parameter rule evaluation data sets which did not immediately precede a failure are tagged as not preceding a failure. Suitable values for tagging the rule evaluations can include “1” and “0”, or “T” and “F”, or other similar values.

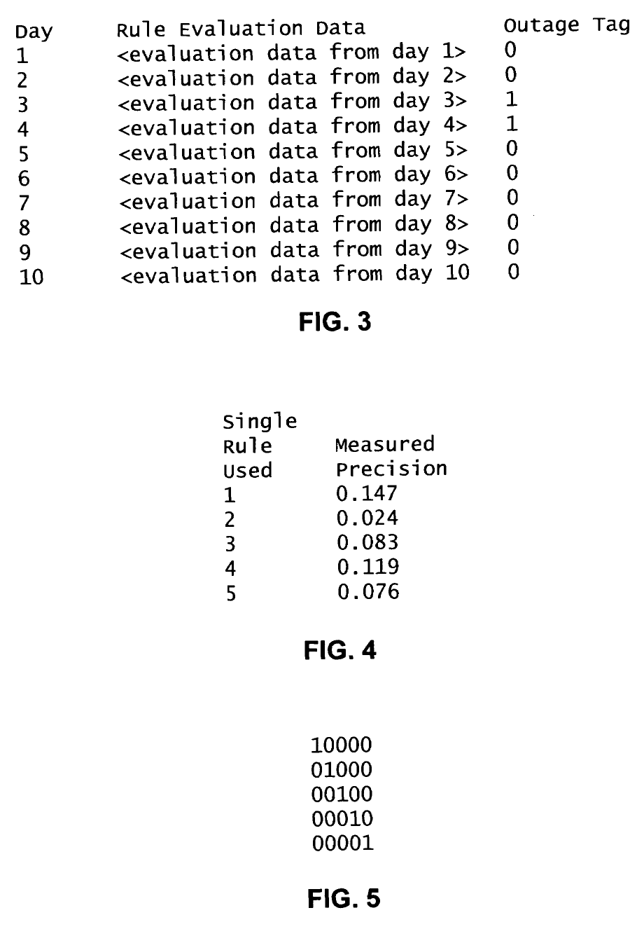

For example, if performance-parameter rules are evaluated on the target system 102 each day from day 1 to day 10, and the target system 102 had a failure after evaluation 3 and 4, then the performance-parameter rule evaluation data can be tagged as indicated in FIG. 3. Note that the results are then transported over a network 106 to a monitoring system 108 and collected for further processing.

In one embodiment of the present invention, sensor data is evaluated along with the performance-parameter rules and tagged in the same manner.

### Optimization-Seeding Phase

In one embodiment of the present invention, an optimization function is applied in turn to each individual performance-parameter rule. For example, if there are 4,000 performance-parameter rules, then the seeding phase executes an optimization function 4,000 times, one time for each individual performance-parameter rule.

A suitable optimization function can be any function which can predict an outcome (output) based on a training data set with historic data showing which combinations of input and output values have been observed and recorded. Possible choices for the optimization function are neural networks, decision trees, logistic regression, or any other suitable optimization function. If the optimization function can only handle numerical inputs, whereas the performance-parameter rule evaluation results are nominal (e.g., “pass”, “fail”, “not applicable”), then the monitoring system 108 converts performance-parameter rule evaluation results to scalars. For example, in one embodiment of the present invention, a “fail” result is converted to a value of “1,” and all other results can be changed to a value of “0”. Note that any conversion to numerical values may be used.

During each execution of the optimization function in the seeding phase, only one performance-parameter rule is used as an input to predict the occurrence of a failure. During this step, the optimization function is trained on a historic data set. After the training step the trained optimization function is validated on a separate data set to measure how well the trained optimization function predicts failures. For example, data from day 1 to 100 may be used for training, and data from day 101 to day 200 may be used for evaluation. The performance of each individual performance-parameter rule for prediction is then recorded. The performance can be measured with several alternative performance measures, such as accuracy, precision, recall, or other similar known metrics.

For example if precision is used as the evaluation function, the first few steps of the seeding step may result in the performance data illustrated in FIG. 4.

At the end of the seeding phase, each performance-parameter rule will have been evaluated as to its suitability to predict failures as a single input to the optimization function, and the performance of each performance-parameter rule has been recorded.

### Genetic-Optimization Phase

In one embodiment of the present invention, during the genetic-optimization phase, a genetic technique is applied to discover combinations of performance-parameter rules which can be used together as multiple inputs to the optimization function to obtain a trained function with high predictive power. As is custom with genetic techniques, two operations can be used to select a subset of performance-parameter rules to be evaluated as inputs: crossover and mutation.

To apply the crossover and mutation operations, the subsets of performance-parameter rules which have already been evaluated are coded as bit vectors. Each subset of performance-parameter rules that have been evaluated are represented by a one bit vector. This is accomplished by creating a binary string with one digit for each performance-parameter rule in the entire set of performance-parameter rules. For example, in one embodiment of the present invention, if there are 4,000 performance-parameter rules, then all bit strings representing subsets of the performance-parameter rules will have 4,000 digits. Each digit indicates whether the corresponding performance-parameter rule is a member of the subset of performance-parameter rules used (“1”), or not used (“0”).

For example, for brevity let's assume that there are only five performance-parameter rules. The bit strings illustrated in FIG. 5 represent the performance-parameter rule subsets evaluated during the seeding phase.

In one embodiment of the present invention, the crossover and mutation operations can then be applied to the coded rule subsets to derive new rule subsets for evaluation. The crossover function randomly selects a crossover point r between 2 and the number of performance-parameter rules. Monitoring system 108 then chooses two parent performance-parameter rule subsets, and generates a new subset by using the initial part of the first bit string up to r−1 and appending the end part of the second bit string beginning at position r.

For example, if there five performance-parameter rules, and the parents have been selected as performance-parameter rule subsets 2 and 4 and r=4, then the new subset will be derived as follows: The initial part of subset 2 from position 1 to 3 is “010” and the end part of performance-parameter rule subset 4 from position 4 to 5 is “10”, so that the new performance-parameter rule subset becomes “01010”. In this case, performance-parameter rules 2 and 4 will become the new subset to be evaluated.

Similarly, the mutation operation selects a single parent and a random mutation position r. Based on the parent and the choice of r, the mutation operation then generates a new coded subset of performance-parameter rules by reversing the bit in position r. For example, “0” becomes “1” and “1” becomes “0”.

In one embodiment of the present invention, during each genetic optimization step, one operation from either “crossover” or “mutation” is chosen at random. Both the crossover and mutation operations can result in the empty subset (the resulting bit string has only zeros) or in subsets which have already been evaluated. In these cases, the crossover or mutation operation is applied again until a suitable new subset is found.

The performance of each newly derived subset is recorded similarly to how this was done during the seeding phase, and the newly evaluated subset of performance-parameter rules is added to the pool of evaluated performance-parameter rules so that it may become a parent performance-parameter rule for future crossover and mutation operations.

In one embodiment of the present invention, a significant aspect in the process of generating new performance-parameter rule subsets for evaluation is the choice of parent subsets for use with crossover and mutation. Note that it is desirable to choose parents with a bias to parents with good performance while not limiting the selection to only the best performing parents. This can be accomplished by sorting the collected performance-parameter rule subset performance data in order of performance, and then randomly selecting parents with a bias toward high performance. For example, assume that there are n already evaluated rule subsets to choose from, sorted in order with the best performing performance-parameter rules listed first. A random real number q between 0.0 and 1.0 is generated, squared, and scaled to a range of 1 to n to obtain the position m of the parent rule to be selected: m=q²*(n−1)+1.

In one embodiment of the present invention, the genetic optimization phase is stopped when a suitable exit criterion has been met. This exit criterion may be the completion of predetermined number of genetic optimization steps, the discovery of a performance parameter subset which achieves a desired minimal performance, or another similar exit criterion. When the exit criterion has been met, the best performing performance-parameter rule subset from among those that have been evaluated is selected for use in the prediction phase.

### Prediction Phase

In one embodiment of the present invention, during the reporting phase, the optimization rule that was learned from the best performing performance-parameter rule subset is deployed to process incoming performance parameter evaluation data set to determine the risk of failure for each target system, such as target system 102.

The performance-parameter rule subsets learned during the genetic optimization phase can be used with existing monitoring systems to predict the failure of target system 102. Such systems can alert an administrator when the probability of a failure exceeds a pre-determined threshold, or can even implement an automatic failover to a backup system. For example, if four performance-parameter rules fail, and those performance-parameter rules in combination have shown a high probability of predicting a failure of target system 102, then it is likely that target system 102 will fail in the near future, and proactive action should be taken to minimize the impact of, or eliminate, a failure of target system 102.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using performance parameters to predict a computer system failure, comprising:
evaluating a performance-parameter rule on a target system to determine if a corresponding performance parameter is within a predetermined range, wherein the performance parameter defines a performance metric for software executing on the computer system;
receiving an evaluation result of the performance-parameter rule from the target system;
recording the evaluation result in a historic data set;
determining if the target system failed within a pre-determined time period subsequent to the evaluation of the performance-parameter rule, and if so, recording the failure of the target system in the historic data set; and
analyzing the historic data set to determine the accuracy of using the performance-parameter rule to predict a failure of the target system.

2. The method of claim 1, wherein prior to analyzing the historic data set, the method further comprises repeating the process of evaluating the performance-parameter rule, receiving the evaluation result, recording the evaluation result, and determining and recording failures of the target system for subsequent time periods.

3. The method of claim 2, further comprising:
evaluating a second performance-parameter rule on the target system to determine if a second performance parameter is within a second predetermined range,
receiving a second evaluation result of the second performance-parameter rule from the target system;
recording the second evaluation result of the second performance-parameter rule in the historic data set;
determining if the target system failed within a pre-determined time period subsequent to the evaluation of the second performance-parameter rule, and if so, recording the failure of the target system in the historic data set;
repeating the process of evaluating the second performance-parameter rule on the target system, receiving the second evaluation result of the second performance-parameter rule, recording the second evaluation result, and determining and recording failures of the target system for subsequent time periods; and
analyzing the historic data set to determine the accuracy of using the second performance-parameter rule to predict a failure of the target system.

4. The method of claim 3, further comprising analyzing the historic data set to determine the accuracy of using a combination of performance-parameter rules to predict a failure of the target system.

5. The method of claim 4, further comprising:
periodically analyzing evaluation results of the performance-parameter rules to determine the probability of an impending failure of the target system; and
if the probability is above a pre-determined threshold, alerting an administrator.

6. The method of claim 5, further comprising implementing an automatic failover of the target system to a backup system if the probability is above a pre-determined threshold.

7. The method of claim 3, further comprising:
receiving data from a sensor monitoring physical attributes of the target system;
recording the data from the sensor in the historic data set;
determining if the target system failed within a pre-determined time period subsequent to recording the data from the sensor in the historic data set, and if so, recording the failure of the target system in the historic data set; and
analyzing the historic data set to determine the accuracy of using a combination of performance parameters and sensor data to predict a failure of the target system.

8. A computer-readable storage medium storing instructions that when executed by a computer cause the computer to perform a method for using performance parameters to predict a computer system failure, the method comprising:
evaluating a performance-parameter rule on a target system to determine if a corresponding performance parameter is within a predetermined range, wherein the performance parameter defines a performance metric for software executing on the computer system;
receiving an evaluation result of the performance-parameter rule from the target system;
recording the evaluation result in a historic data set;
determining if the target system failed within a pre-determined time period subsequent to the evaluation of the performance-parameter rule, and if so, recording the failure of the target system in the historic data set; and
analyzing the historic data set to determine the accuracy of using the performance-parameter rule to predict a failure of the target system.

9. The computer-readable storage medium of claim 8, wherein prior to analyzing the historic data set, the method further comprises repeating the process of evaluating the performance-parameter rule, receiving the evaluation result, recording the evaluation result, and determining and recording failures of the target system for subsequent time periods.

10. The computer-readable storage medium of claim 9, wherein the method further comprises:
evaluating a second performance-parameter rule on the target system to determine if a second performance parameter is within a second predetermined range,
receiving a second evaluation result of the second performance-parameter rule from the target system;
recording the second evaluation result of the second performance-parameter rule in the historic data set;
determining if the target system failed within a pre-determined time period subsequent to the evaluation of the second performance-parameter rule, and if so, recording the failure of the target system in the historic data set;
repeating the process of evaluating the second performance-parameter rule on the target system, receiving the second evaluation result of the second performance-parameter rule, recording the second evaluation result, and determining and recording failures of the target system for subsequent time periods; and
analyzing the historic data set to determine the accuracy of using the second performance-parameter rule to predict a failure of the target system.

11. The computer-readable storage medium of claim 10, wherein the method further comprises analyzing the historic data set to determine the accuracy of using a combination of performance-parameter rules to predict a failure of the target system.

12. The computer-readable storage medium of claim 11, wherein the method further comprises:
periodically analyzing evaluation results of the performance-parameter rules to determine the probability of an impending failure of the target system; and
if the probability is above a pre-determined threshold, alerting an administrator.

13. The computer-readable storage medium of claim 12, wherein the method further comprises implementing an automatic failover of the target system to a backup system if the probability is above a pre-determined threshold.

14. The computer-readable storage medium of claim 10, wherein the method further comprises:
receiving data from a sensor monitoring physical attributes of the target system;
recording the data from the sensor in the historic data set;
determining if the target system failed within a pre-determined time period subsequent to recording the data from the sensor in the historic data set, and if so, recording the failure of the target system in the historic data set; and
analyzing the historic data set to determine the accuracy of using a combination of performance parameters and sensor data to predict a failure of the target system.

15. An apparatus configured for using performance parameters to predict a computer system failure, comprising:
an evaluation mechanism configured to evaluate a performance-parameter rule on a target system to determine if a corresponding performance parameter is within a predetermined range, wherein the performance parameter defines a performance metric for software executing on the computer system;
a receiving mechanism configured to receive an evaluation result of the performance-parameter rule from the target system;
a recordation mechanism configured to record the evaluation result in a historic data set;
a determination and recordation mechanism configured to determine if the target system failed within a pre-determined time period subsequent to the evaluation of the performance-parameter rule, and if so, to record the failure of the target system in the historic data set; and
an analysis mechanism configured to analyze the historic data set to determine the accuracy of using the performance-parameter rule to predict a failure of the target system.

16. The apparatus of claim 15:
wherein the evaluation mechanism is further configured to evaluate a second performance-parameter rule on the target system to determine if a second performance parameter is within a second predetermined range,
wherein the receiving mechanism is further configured to receive a second evaluation result of the second performance-parameter rule from the target system;
wherein the recordation mechanism is further configured to record the second evaluation result of the second performance-parameter rule in the historic data set;
wherein the determination and recordation mechanism configured to determine if the target system failed within a pre-determined time period subsequent to the evaluation of the second performance-parameter rule, and if so, to record the failure of the target system in the historic data set; and
wherein the analysis mechanism is further configured to analyze the historic data set to determine the accuracy of using the second performance-parameter rule to predict a failure of the target system.

17. The apparatus of claim 16, further comprising a prediction mechanism configured to analyze the historic data set to determine the accuracy of using a combination of performance-parameter rules to predict a failure of the target system.

18. The apparatus of claim 17, wherein the prediction mechanism is further configured to periodically analyze evaluation results of the performance-parameter rules to determine the probability of an impending failure of the target system, and if the probability is above a pre-determined threshold, to alert an administrator.

19. The apparatus of claim 18, wherein the prediction mechanism is further configured to implement an automatic failover of the target system to a backup system if the probability is above a pre-determined threshold.

20. The apparatus of claim 16:
wherein the receiving mechanism is further configured to receive data from a sensor monitoring physical attributes of the target system;
wherein the recordation mechanism is further configured to record the data from the sensor in the historic data set;
wherein the determination and recordation mechanism configured to determine if the target system failed within a pre-determined time period subsequent to recording the data from the sensor in the historic data set, and if so, to record the failure of the target system in the historic data set; and
wherein the analysis mechanism is further configured to analyze the historic data set to determine the accuracy of using a combination of performance parameters and sensor data to predict a failure of the target system.
